(19) United States
(12) Patent Application Publication
(10) Pub. No.: US 2008/0229143 A1
(43) Pub. Date: Sep. 18, 2008

(54) Management of available circuits to repair defective circuits

(75) Inventor: Yosuke Muraki, Campbell, CA (US)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc., Tokyo (JP)

(21) Appl. No.: 11/525,374

(22) Filed: Sep. 21, 2006

(51) Int. Cl. G06F 11/20

(52) U.S. Cl. 714/5; 714/3; 714/E11.084

(57) ABSTRACT

Systems and methods are provided for management of available, possibly redundant, circuits, in particular memory circuits, possibly found in defective processors, to repair defective circuits, in particular memory circuits, such as shared memory, wherein functional memory of a potentially-deactivated available circuit may be activated and used in place of dysfunctional memory of an enabled circuit.

### BACKGROUND

The present invention relates to methods and apparatus for managing available, possibly redundant, circuits, such as memory, possibly found in defective processors, and repairing defective circuits, such as shared memory regions of a multiprocessing system within an integrated circuit.

Large scale integrated circuits are being designed to accommodate an ever increasing number of circuits in order to achieve higher and higher functionality. For example, digital circuits (or analog circuits) are being designed with very high numbers of gates and other functional circuitry to meet processing objectives in the marketplace. As the complexity of integrated circuits (ICs) continue to increase, however, the number of transistors and other components used to implement the circuitry also increases and the probability of a faulty component or circuit occurring in an IC approaches one. The existence of a faulty circuit or component may require that the IC be discarded.

Referring to prior art FIG. 1, it has been proposed to use redundant circuits on the IC in order to permit replacement of the circuitry containing a faulty component. For example, FIG. 1 illustrates an IC 10 employing digital circuit A, digital circuit B, digital circuit C, and digital circuit D, where one or more of the circuits may be redundant. Thus, even when a fault occurs, the IC 10 may be salvaged by enabling the redundant circuit. This can increase the IC yield and save the IC manufacturer a considerable amount of money. While the redundant circuit(s) may be activated and used in place of the faulty components, the faulty component may be deactivated. Conventional techniques for activating good circuits and deactivating faulty circuits include blowing fuses, such as electrical fuses (e-fuses) and/or laser-trimmed fuses. Software-based techniques may include programming instructions to redirect data, either to a good circuit, enabling it, or from a bad circuit, disabling it.

The components or circuits of an IC may be faulty due to improper fabrication. For example, an imperfection may have been present on the substrate during fabrication or the fabrication procedure itself may be faulty. Improperly fabricated ICs may be discovered during IC testing, prior to packaging. If a faulty component is discovered on an IC during pre-packaging IC testing, the faulty component may be deactivated and a redundant circuit activated to take its place through the blowing of certain fuses, preferably, laser fuses since access to the IC is possible because the IC has yet to be packaged.

ICs may also be damaged after the pre-packaging IC testing. The components or circuits of an IC may be faulty due to damage during the packaging of the IC, for example, when the die is cut from the wafer, when the wafer is cleaned, when the die is bonded to the packaging, and so forth. ICs that become faulty due to packaging are usually not discovered until post-packaging testing. Since the packaging of an IC can be a considerable amount of the overall cost of manufacturing the IC, simply discarding a faulty IC could be expensive.

A conventional technique proposes the use of additional redundant circuits that can be activated in place of the faulty components discovered in post-packaging IC testing. These additional redundant circuits can be activated through the use of electrical fuses (e-fuses) or software fixes, rather than laser fuses, since direct access to the IC is not possible. This can permit the use of a packaged IC that would have otherwise been discarded.

In order to minimize the complexity of the power and clock distribution networks of the IC, the redundant circuitry usually shares common power and clock distribution networks with the other circuits of the IC. Thus, in the majority of IC, the redundant circuitry is being actively clocked and powered although it is not being used. This configuration leaves open the possibility of accessing the redundant circuit for other purposes. Similarly, when a circuit containing a fault is disabled, it still may be actively clocked and powered, which contributes to power consumption, but also leaves open the possibility of accessing the faulty circuit for other purposes.

In the context of the present invention, it is noted that some ICs are designed with a plurality of circuits that are intended more for parallel functionality as opposed to redundancy. For example, in a parallel processing system, a number of processing circuits may be disposed in an IC, where each of the processors may operate in series or parallel to achieve a processing objective. While the processors may be redundant in the sense that they can perform the same functions, they are primarily provided for operation in parallel (and/or series) to increase processing performance.

Thus, other techniques to permit enabling and disabling of circuitry on an IC are needed that better manage and use redundant and faulty circuits.

### SUMMARY OF THE INVENTION

Systems, methods and apparatus are provided for management of redundant memory, possibly found in defective processors, to repair defective memory, such as in shared memory. Utilization of previously unused or unusable components raises the product yield, thereby keeping systems cost-efficient.

In accordance with one or more additional embodiments of the invention, functional memory of an available circuit may be activated and used in place of dysfunctional memory of an enabled circuit. The available circuit may include a fully-functional redundant circuit or a partially-functional redundant circuit. The available circuit have been disabled prior to its use. The fully-functional redundant circuit may include a functional logic processor and a functional memory, whereas the partially-functional redundant circuit may include a dysfunctional logic processor and a functional memory.

Activation and use of functional memory in place of dysfunctional memory may be characterized as repairing or repair of the dysfunctional memory with the functional memory. Activating the functional memory of the available circuit may include mapping a defective region address, associated with a defective region of the dysfunctional memory, to a repair region address, associated with a repair region of the functional memory. Using the functional memory in place of the dysfunctional memory may include redirecting circuitry communications away from the defective region address and to the repair region address, based on the mapping.

In accordance with one or more further embodiments of the invention, a method of repairing a defect in a shared memory using a functional memory of an available processor may comprise: performing a memory check of the shared memory; identifying the defect in the shared memory, the defect being located in a defective region having a defective region address; recording identification details about identifying the defect; assigning a repair region of the functional memory to function in place of the defective region, the repair region having a repair region address; recording assignment details about assigning the repair region; cross-referencing the identification details and the assignment details; redirecting to the repair region address an access request sent to the defective region address; and adding an appropriate latency to the access request.

A preferred implementation of the present invention may utilize a microprocessor architecture known as Cell Broadband Engine Architecture, commonly abbreviated “CBEA,” “Cell BE,” or simply “Cell.” The CBEA combines a light-weight general-purpose POWER-architecture core of modest performance with multiple GPU-like streamlined coprocessing elements into a coordinated whole, with a sophisticated memory coherence architecture. POWER is a backronym for “Performance Optimization With Enhanced RISC” and refers to a RISC instruction set architecture, as well as a series of microprocessors that implements the instruction set architecture.

The CBEA greatly accelerates multimedia and vector processing applications, as well as many other forms of dedicated computation. The CBEA emphasizes efficiency over watts, bandwidth over latency, and peak computational throughput over simplicity of program code.

The CBEA can be split into four components: external input and ouput structures; the main processor called the POWER Processing Element (“PPE”) (a two-way simultaneous multithreaded POWER 970 architecture compliant core); eight fully functional co-processors called the Synergistic Processing Elements (“SPEs”); and a specialized high bandwidth circular data bus connecting the PPE, input/output elements and the SPEs, called the Element Interconnect Bus (“EIB”) . To achieve the high performance needed for mathematically intensive tasks such as decoding/encoding MPEG streams, generating or transforming three dimensional data, or undertaking Fourier analysis of data, the CBEA marries the SPEs and the PPE via the EIB to give the SPEs and the PPE access to main memory or other external data storage.

Within the Cell Broadband Engine Architecture, a Broadband Engine (BE) may include one or more PPEs. The PPE is capable of running a conventional operating system and has control over the SPEs, allowing it to start, stop, interrupt and schedule processes running on the SPEs. To this end, the PPE has additional instructions relating to control of the SPEs. Despite having Turing complete architectures, the SPEs are not fully autonomous and require the PPE to initiate them before they can do any useful work. Most of the “horsepower” of the system comes from the synergistic processing elements, SPEs.

Each SPE is composed of a “Streaming Processing Unit” (“SPU”), and a Synergistic Memory Flow (SMF) controller unit. The SMF may have a digital memory access (DMA), a memory management unit (MMU), and a bus interface. An SPE is a RISC processor with 128-bit single-instruction, multiple-data (SIMD) organization for single and double precision instructions. With the current generation of the CBEA, each SPE contains a 256 KiB instruction and data local memory area (called “local store”) which is visible to the PPE and can be addressed directly by software. Each of these SPE can support up to 4 GB of local store memory, as static random access memory (SRAM). The local store does not operate like a conventional CPU cache since it is neither transparent to software nor does it contain hardware structures that predict what data to load.

By way of example, a CBEA multiprocessing system may have a potential of eight valid SPEs in a common IC. As discussed above, as the CBEA is manufactured, one of the SPEs may become faulty and, therefore, the overall performance of the IC may be reduced. Instead of discarding the IC, the reduced performance multiprocessing system may be used in an application (e.g., a product) that does not require a full complement of SPEs. For example, a high performance video game product may require a full complement of SPEs; however, a digital television (DTV) might not require a full complement of SPEs. Depending on the complexity of the application in which the multiprocessing system is to be used, a lesser number of SPEs may be employed by disabling the faulty SPE and using the resulting multiprocessing system in a less demanding environment (such as a DTV).

To account for the high probability that some portion of the CBEA yield will have at least one faulty SPE, a Cell BE processor may be allowed to pass the fabrication test if 7 out of 8 SPEs are good. Even if all 8 SPEs are good on a Cell BE, known as an “all good” sample, it may be desirable still to disable one of the 8 SPES, so that all shipped Cell BEs for a given product have 7 working SPEs, leaving one SPE redundant. In addition, disabling one SPE, even though it is not faulty, of an application not requiring a full complement of SPEs, should reduce power consumption in the application to help achieve performance goals. Various benefits and uses of redundant SPEs, as well as exemplary methods of disabling, or deactivating, the redundant SPE, are described in U.S. Pat. No. 6,785,841 to Akrout et al. If at least partially functional, the redundant SPE may available for other uses, representing an available circuit.

In an all-good sample, all SPEs are fully-functional, and thus the redundant SPE has a functional logic processor (SPU) and functional memory (local store). In a 7-of-8 sample, 7 of the SPEs are fully functional, and one SPE is faulty. The faulty SPE may be defective for numerous reasons, and depending on the circumstances, part of the SPE nonetheless may be functional, resulting in a partially-functional SPE. Although the SPU of a bad SPE may fail, its local store nonetheless may function, known as a “logic-fail SPE.” Once part of a system, the BE is connected to a shared memory (XDRAM), and the shared memory chips that are connected to BEs heretofore have needed to be defect-free.

However, as with other components of the system, the shared memory may contain a defect arising during manufacturing, and to make matters worse, the defect in the shared memory may surface first after it has been connected to the system. In accordance with the present invention, the shared memory, while not defect-free, nonetheless may contain minor defects that are repaired using an available circuit. As long as a shared memory defect is minor enough that the shared memory may still function, albeit impaired, and the available circuit has a repair region capable of repairing the defective region, then the system may use the available circuit to repair the shared memory.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings, wherein like numerals indicate like elements, forms that are presently preferred, it being understood, however, that the invention is not limited to the precise arrangements and instrumentalities shown, but instead only by the claims.

FIG. 1 is a block diagram illustrating the structure of a system employing redundant circuitry in accordance with the prior art.

FIG. 2 is a diagram illustrating a multiprocessing system in accordance with one or more embodiments of the present invention.

FIG. 3 is a flow diagram illustrating a process that may be carried out by the system of FIG. 2 (or other system described herein) according to one or more further embodiments of the present invention.

FIG. 4 is a diagram illustrating a broadband engine (BE) that may be used to implement one or more further aspects of the present invention.

FIG. 5 is a diagram illustrating the structure of an exemplary synergistic processing element (SPE) of the system of FIG. 4 that may be adapted in accordance with one or more further aspects of the present invention.

FIG. 6 is a diagram illustrating the structure of an exemplary POWER processing element (PPE) of the system of FIG. 4 that may be adapted in accordance with one or more further aspects of the present invention.

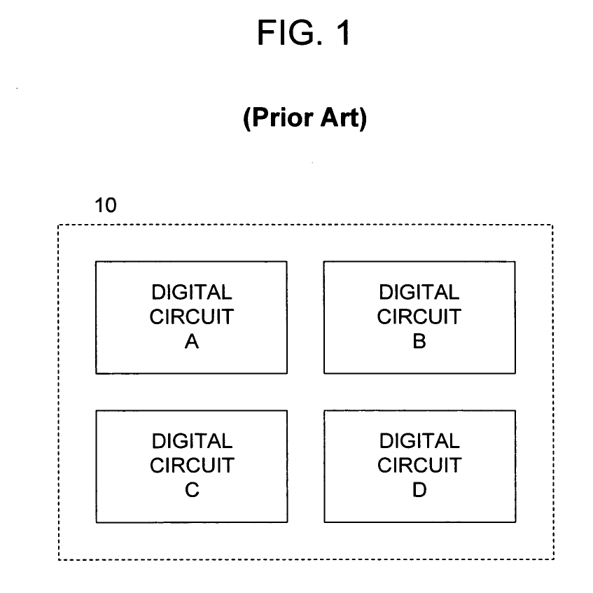

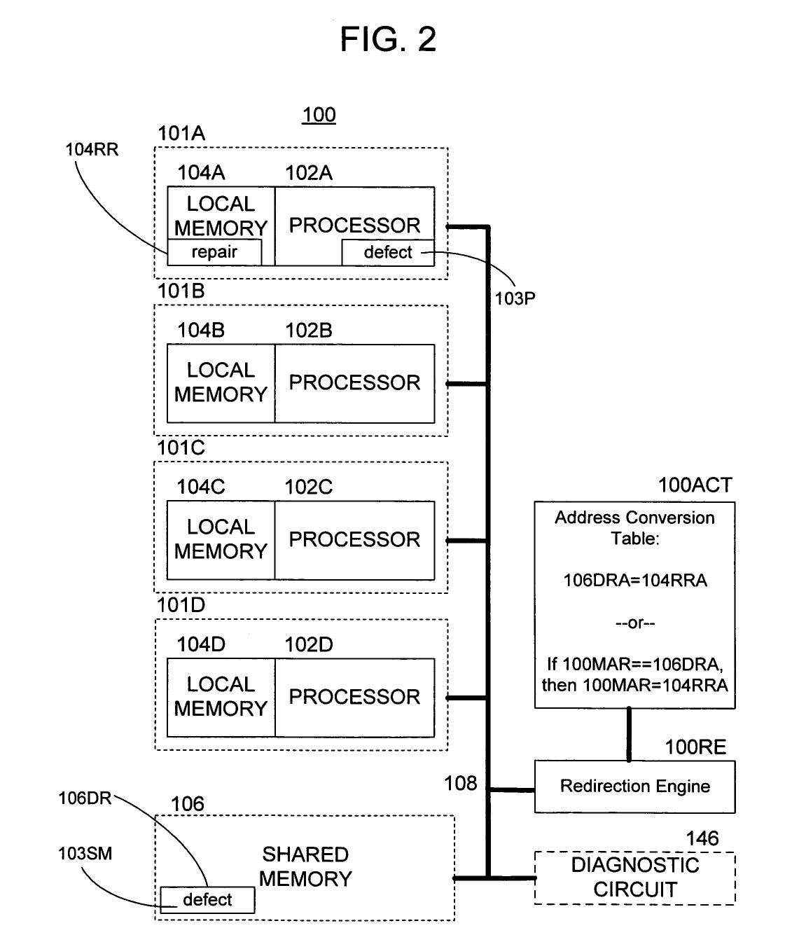

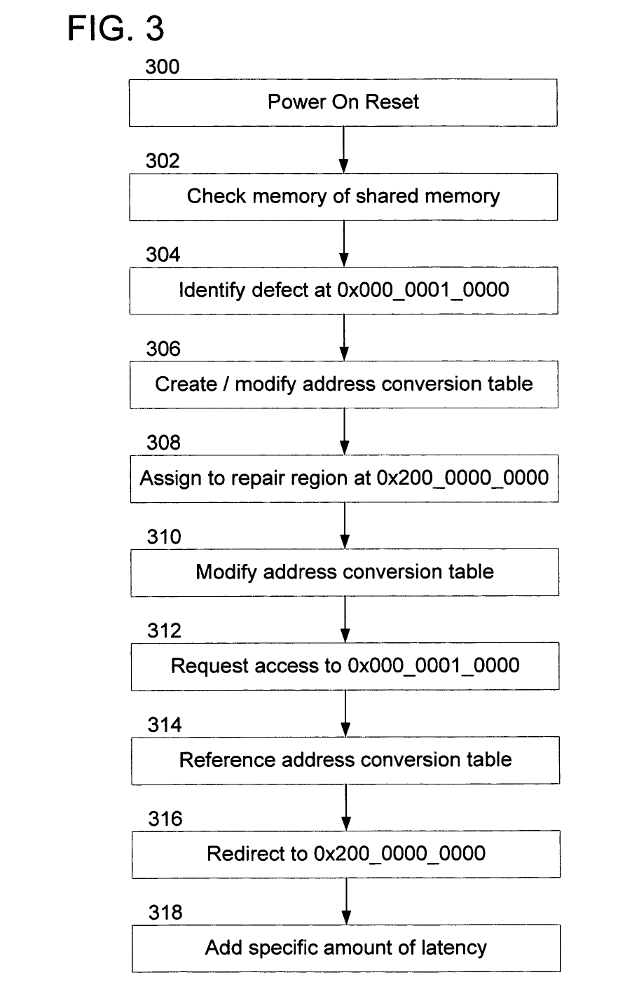

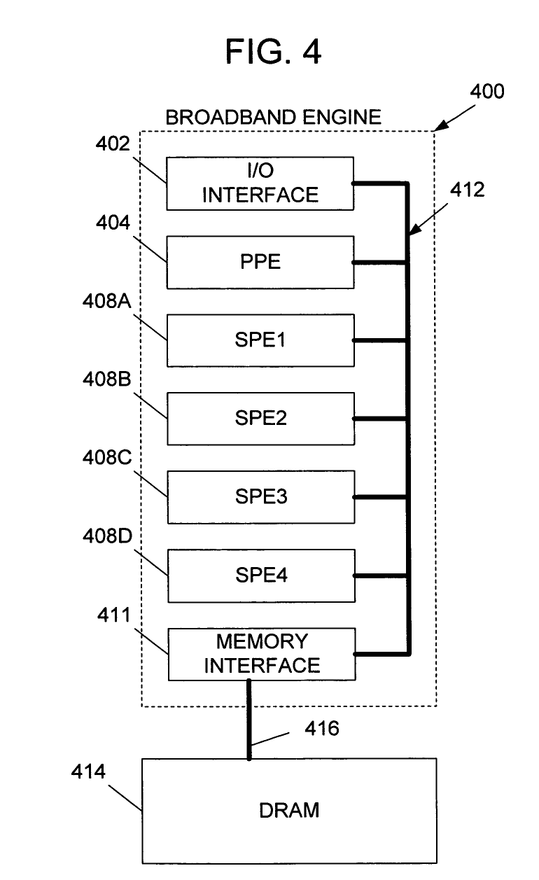

### DETAILED DESCRIPTION OF THE PRESENT INVENTION

Whereas FIG. 1 sets forth a prior art configuration of a redundant circuit architecture, FIGS. 2 and 3 and their descriptions focus on a generic architecture and process by which an embodiment of the present invention may be implemented. Furthermore, FIGS. 4-6 set forth specific aspects of system architectures according to preferred embodiments of the present invention.

Referring to FIG. 2, a block diagram depicts a multi-processing system 100 that may be adapted to implement the features discussed herein and one or more further embodiments of the present invention. The system 100 includes a plurality of processors 102A-D, associated local memories 104A-D, and a shared memory 106 interconnected by way of a bus 108. The shared memory 106 may also be referred to herein as a main memory or system memory. The local memory 104 may be referred to as local store. The methods and/or circuit functionality discussed in FIGS. 3-6 may also be applied to the circuit configuration of FIG. 2.

A processor 102, and any associated local store 104, may form a circuit block 101 of FIG. 2. Shared memory 106 is shown as having a defect 103SM. Assuming that the defect 103SM does not cover the entire shared memory 106, the defect 103SM will be characterized as existing in a defective region 106DR of shared memory 106. Similarly, among the four circuit blocks 101A-D, processor 102A is shown as having a defect 103P and is hence dysfunctional, or faulty. In this scenario, circuit block 101A is considered a “logic-fail” circuit block because the defect 103P is in the processor 102A, and not in the local store 104A. As such, circuit block 101A may be characterized as partially-functional. Not having any defects, circuit blocks 101B-D would be considered fully-functional.

Assuming that the system 100 needs only three circuits blocks 101B-D to pass the fabrication test, circuit block 101A also may be considered redundant (as opposed to essential, which would require rejection of system 100), and hence available. In contrast, given this assumption, but in the absence of defect 103P, circuit block 101A would be a fully-functional redundant circuit. In this context, redundancy indicates that the circuit or memory is no longer needed for its primary, intended purpose. Similarly, a circuit that is not being used, in whole or in part, is available for use, in whole or in part, for primary as well as secondary purposes for which the circuit is suitable.

In this scenario where three of the four circuit blocks 101A-D need to be fully-functional, fabrication guidelines may instruct, for various reasons such as uniformity, that only three fully-functional circuit blocks 101 are operational when the system 100 is shipped. Hence, even if all four circuit blocks 101A-D were fully functional, one fully-functional circuit block 101 would be deactivated, or disabled, as redundant. Otherwise, if one circuit block 101A is not fully-functional, it would be the natural choice to be characterized as redundant and deactivated or disabled.

If shared memory 106 is on a separate chip, this deactivation or disablement may occur before the circuit block 101 is combined with the shared memory 106 on a final board of system 100. If shared memory 106 is on the same chip, this deactivation or disablement may occur after the circuit block 101 is combined with the shared memory 106 on a final board of system 100. In any event, the defect 103SM on the shared memory 106 may not be detected until fabrication of the system 100. If defect 103SM were detected prior to installation, shared memory 106 previously might have been discarded, but if detected after installation, the entire system 100 previously might have needed to be discarded. The present invention reduces both these risks of disposal by providing a way to salvage the shared memory 106 in spite of defect 103SM.

If the defect 103SM does not prevent the rest of shared memory 106 from functioning, then, in accordance with one or more embodiments of the present invention, shared memory 106 may be repaired using local store 104A of deactivated circuit block 101A. In this context, “repair” does not connote a physical correction or removal of an imperfection causing defect 103SM, but rather the restoration of shared memory 106 to its intended functionality via the assistance of local store 104A. The functional memory 104A of a disabled circuit 101A may be activated and used in place of dysfunctional memory 106DR.

In general, assuming that one circuit 101 is disabled, the disabled circuit 101 may be a fully-functional circuit, e.g. 101B-D, which is redundant if the set of circuits is all-good, or a partially-functional redundant circuit, if the disabled circuit is a logic-fail circuit 101A. Generally speaking, the fully-functional redundant circuit may include a functional logic processor, e.g., 102B-D, and a functional memory, e.g., 104B-D, whereas the partially-functional redundant circuit 101A may include a dysfunctional logic processor 102A and a functional memory 104A. If a circuit 101 is disabled because the local memory 104 is faulty, causing the processor 102 to fail, then it is a memory-fail circuit, and the local store 104 cannot be used to repair defective regions 106DR.

Shared memory 106 may be repaired may be in part or in full, depending on the memory capacity of local store 104A vis-à-vis the intended memory capacity of the defective region 106DR. The portion of the redundant functional memory 104A that is used to repair the defective region 106DR may be characterized as a repair region 104RR. Preferably, repair region 104RR has a memory capacity approximately that equals the intended memory capacity of the defective region 106DR.

Inasmuch as both the shared memory 106 and the local store 104A may be addressable, location-specific data storage, each memory sector may have an address. Thus, the defective region 106DR may have a defective region address 106DRA, whereas the repair region 104RR may have a repair region address 104RRA. Repairing a defective region 106DR may include mapping in an address conversion table 100ACT the defective region address 106DRA to a repair region address 104RRA. From a computer programming perspective, this may be accomplished in various ways known in the art. For instance, the defective region address 106DRA may be assigned the value of repair region address 104RRA, or a conditional statement may test a memory access request 100MAR for the defective region address 106DRA and, if true, assign the memory access request 100MAR the value of the repair region address 104RRA.

Referring to FIG. 3, exemplary process steps of repairing defective memory and managing redundant memory are shown in combination. In step 300, a power-on reset may be performed. In step 302, the shared memory 106 may be checked for defects 103SM and errors. If a defect 103SM is found, a defective region 106DR may be identified (step 304). An address conversion table 100ACT may be created, or an existing table 100ACT may be modified, in step 306, to reflect the identification details of the defective region 106DR. The address conversion table 100ACT may be stored, for example, in the FLASH or EEPROM memory (not shown) of the system 100. If available, a repair region 104RR may be identified and assigned for the defective region 106DR (step 308), and the assignment details of the repair region 104RR may be recorded by modifying the address conversion table 100ACT (step 310). Hence, the defective region address 106DRA may be mapped to the repair region address 104RRA.

In practice, if the system 100 sends a memory access request 100MAR in an attempt to access the defective region 106DR (step 312), the address conversion table 100ACT may be referenced (step 314), indicating that the defective region address 106DRA has been mapped to the repair region address 104RRA. In view of the mapping, the memory access request 100MAR may be redirected to the repair region 104RR (step 316). The redirection may be accomplished by various means, such as a redirection engine 100RE configured to check memory access requests and redirect those sent to defective region addresses.

To the extent that shared memory 106 may be DRAM-type data storage and local store 104A may be SRAM-type data storage, the local store 104A may perform much faster than the shared memory 106. Thus, in order to mimic the performance that would be associated with accessing defective region 106DR, a specific amount of latency may be added, for instance by the redirection engine 100RE, when accessing repair region 104RR (step 318). Conversely, if the defective region performed faster than the repair region, the latency could be adjusted down to minimum response time of the repair region. If necessary, a memory access request response may be sent to indicate that the repair region will respond slower than the defective region would have. In general, however, the redirection engine 100RE may adjust the latency according to the performance speeds of the repair region and defective region.

Although four processors 102 are illustrated by way of example, any number may be utilized without departing from the spirit and scope of the present invention. Each of the processors 102 may be of similar construction or of differing construction. The local memories 104 are preferably located on the same chip (same semiconductor substrate) as their respective processors 102; however, the local memories 104 are preferably not traditional hardware cache memories in that there are no on-chip or off-chip hardware cache circuits, cache registers, cache memory controllers, etc. to implement a hardware cache memory function.

The processors 102 preferably provide data access requests to copy data (which may include program data) from the system memory 106 over the bus 108 into their respective local memories 104 for program execution and data manipulation. The mechanism for facilitating data access is preferably implemented utilizing a direct memory access controller (DMAC), not shown. The DMAC of each processor is preferably of substantially the same capabilities as discussed hereafter with respect to other features of the invention.

The system memory 106 is preferably a dynamic random access memory (DRAM) coupled to the processors 102 through a high bandwidth memory connection (not shown). Although the system memory 106 is preferably a DRAM, the memory 106 may be implemented using other means, e.g., a static random access memory (SRAM), a magnetic random access memory (MRAM), an optical memory, a holographic memory, etc.

Each processor 102 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processors 102 may include an instruction buffer, instruction decode circuitry, dependency check circuitry, instruction issue circuitry, and execution stages.

In one or more embodiments, the processors 102 and the local memories 104 may be disposed on a common semiconductor substrate. In one or more further embodiments, the shared memory 106 may also be disposed on the common semiconductor substrate or it may be separately disposed.

In one or more alternative embodiments, one or more of the processors 102 may operate as a main processor operatively coupled to the other processors 102 and capable of being coupled to the shared memory 106 over the bus 108. The main processor may schedule and orchestrate the processing of data by the other processors 102. Unlike the other processors 102, however, the main processor may be coupled to a hardware cache memory, which is operable to cache data obtained from at least one of the shared memory 106 and one or more of the local memories 104 of the processors 102. The main processor may provide data access requests to copy data (which may include program data) from the system memory 106 over the bus 108 into the cache memory for program execution and data manipulation utilizing any of the known techniques, such as DMA techniques.

In accordance with one or more embodiments, the multi-processor system 100 may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor 102 in the multi-processor system 100 must complete tasks in a short and predictable time.

To this end, and in accordance with this computer architecture, all processors 102 of a multi-processing computer system 100 are constructed from a common computing module (or cell). This common computing module has a consistent structure and preferably employs the same instruction set architecture. The multi-processing computer system 100 can be formed of one or more clients, servers, PCs, mobile computers, game machines, PDAs, set top boxes, appliances, digital televisions and other devices using computer processors.

A plurality of the computer systems 100 may also be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

As mentioned in reference to FIG. 2, redundant circuits 101 may be deactivated, and potentially activated or reactivated if used in repairing defective regions of memory. Moreover, if a fully-functional redundant circuit is deactivated, but a circuit otherwise left active becomes dysfunctional, the fully-functional deactivated circuit may be activated to replace the dysfunctional circuit, which would then be deactivated. As such, selective activation and deactivation of circuits in a multi-processor system 100 may be accomplished using known methods.

It is understood that any number of circuit blocks 101 may be employed without departing from the spirit and scope of the one or more embodiments of the invention. The circuit blocks 101 are generally operable to produce one or more output signals in response to operating power and one or more input signals. For example, the circuit blocks 101 may be digital circuits, such as combinational logic circuits, processing circuits, microprocessor circuits, digital signal processing circuits, etc.

In a preferred embodiment, circuit blocks 101 include processors 102 that may be implemented utilizing any of the known technologies that are capable of requesting data from a system memory (not shown), and manipulating the data to achieve a desirable result. For example, the processors 102 may be implemented using any of the known microprocessors that are capable of executing software and/or firmware, including standard microprocessors, distributed microprocessors, etc. By way of example, the processors 102 may be graphics processors that are capable of requesting and manipulating data, such as pixel data, including gray scale information, color information, texture data, polygonal information, video frame information, etc.

The circuit blocks 101 are preferably tested during manufacture to determine whether they are faulty. A diagnostic circuit 146 may determine whether each circuit 101 is (1) essential or redundant, and (2) fully-functional, partially-functional or non-functional. Such information may be programmed into the system 100, such as in the diagnostic circuit 146.

A faulty circuit 101 may either be entirely non-functional or partially functional, depending on what aspect of the circuit is defective. In an alternative embodiment, some circuit blocks 101 may be designated fully-functional but redundant, in order to reduce the number of operational circuits 101 in the system 100. A functionality status may track the level of functionality of a circuit and may identify the circuit 101 as redundant or non-redundant. For instance, an available, partially-functional circuit may go from being redundant to non-redundant if it is used to repair another circuit.

Distinguishing between circuits 101 of redundant status or non-redundant status, and non-functional status, partially-functional status, or fully-functional status may be useful in managing the circuits 101 for repair of other circuits 101 or shared memory 106. In either case, the functionality status designation of a to-be-disabled circuit 101 is preferably noted and used to program the selective activation and deactivation of the circuits 101. The note may indicate also, for instance, the reason for deactivation, which aspects of the to-be-disabled circuit 101 are functional, and which are non-functional, in the event that circumstances make it desirable to enable or activate part or all of the to-be-disabled circuit 101. Such a change in circumstances may be determined by the diagnostic circuit 146, which may perform periodic diagnostic checks of the system 100 to detect defects, errors, and other performance issues.

Likewise, if circumstances change so that an active circuit 101 becomes non-functional in whole or in part, the system 100 may reference the functionality status designations of the disabled circuits 101 in search of a circuit 101 that may be activated or enabled in whole or in part to replace the functionality of the now-non-functional aspect(s) of the circuit 101 that will need to be deactivated.

A description of a preferred computer architecture for a multi-processor system is provided in FIGS. 4-6 that is suitable for carrying out one or more of the features discussed herein.

Referring to FIG. 4, a preferred structure of a basic processing module is shown as a broadband engine (BE) 400. The BE 400 comprises an I/O interface 402, a POWER processing element (PPE) 404, and a plurality of synergistic processing elements 408, namely, synergistic processing element 408A, synergistic processing element 408B, synergistic processing element 408C, and synergistic processing element 408D. A local (or internal) BE bus 412 transmits data and applications among the PPE 404, the synergistic processing elements 408, and a memory interface 411. The local BE bus 412 can have, e.g., a conventional architecture or can be implemented as a packet-switched network. If implemented as a packet switch network, while requiring more hardware, increases the available bandwidth.

The BE 400 can be constructed using various methods for implementing digital logic. The BE 400 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The BE 400 also may be implemented using superconducting material, e.g., rapid single-flux-quantum (RSFQ) logic.

The BE 400 is closely associated with a shared (main) memory 414 through a high bandwidth memory connection 416. Although the memory 414 preferably is a dynamic random access memory (DRAM), the memory 414 could be implemented using other means, e.g., as a static random access memory (SRAM), a magnetic random access memory (MRAM), an optical memory, a holographic memory, etc.

The PPE 404 and the synergistic processing elements 408 are preferably each coupled to a memory flow controller (MFC) including direct memory access DMA functionality, which in combination with the memory interface 411, facilitate the transfer of data between the DRAM 414 and the synergistic processing elements 408 and the PPE 404 of the BE 400. It is noted that the DMAC and/or the memory interface 411 may be integrally or separately disposed with respect to the synergistic processing elements 408 and the PPE 404. Indeed, the DMAC function and/or the memory interface 411 function may be integral with one or more (preferably all) of the synergistic processing elements 408 and the PPE 404. It is also noted that the DRAM 414 may be integrally or separately disposed with respect to the BE 400. For example, the DRAM 414 may be disposed off-chip as is implied by the illustration shown or the DRAM 414 may be disposed on-chip in an integrated fashion.

The PPE 404 can be, e.g., a standard processor capable of stand-alone processing of data and applications. In operation, the PPE 404 preferably schedules and orchestrates the processing of data and applications by the synergistic processing elements. The synergistic processing elements preferably are single instruction, multiple data (SIMD) processors. Under the control of the PPE 404, the synergistic processing elements perform the processing of these data and applications in a parallel and independent manner. The PPE 404 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PPE 404 may be implemented by one of the synergistic processing elements 408 taking on the role of a main processing unit that schedules and orchestrates the processing of data and applications by the synergistic processing elements 408. Further, there may be more than one PPE implemented within the broadband engine 400.

In accordance with this modular structure, the number of BEs 400 employed by a particular computer system is based upon the processing power required by that system. For example, a server may employ four BEs 400, a workstation may employ two BEs 400 and a PDA may employ one BE 400. The number of synergistic processing elements 408 of a BE 400 assigned to processing a particular software cell depends upon the complexity and magnitude of the programs and data within the cell.

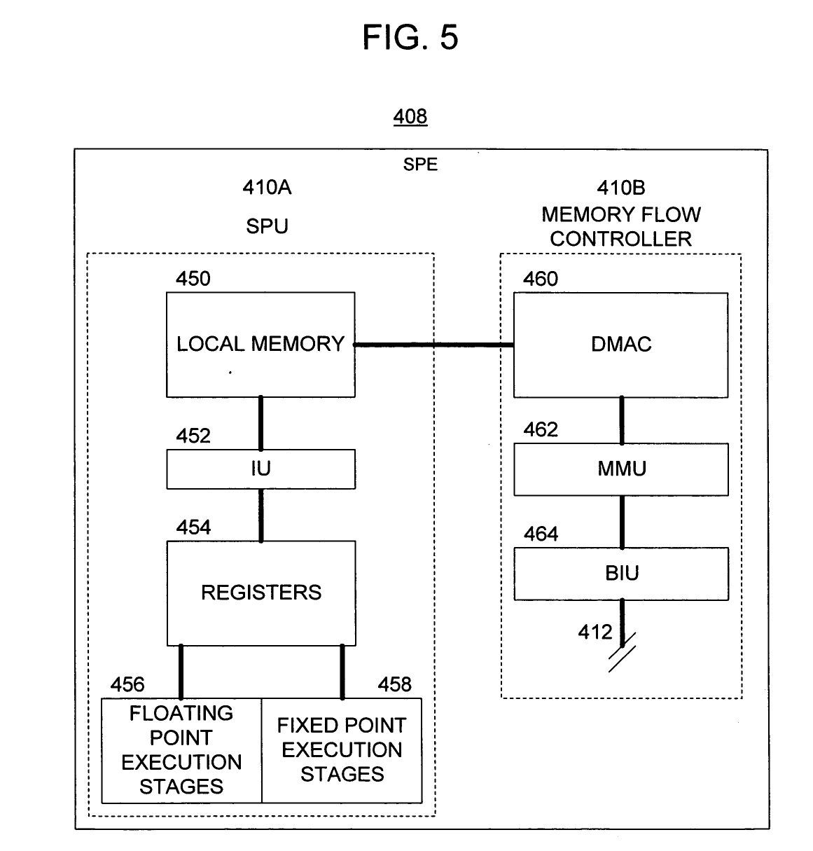

Referring to FIG. 5, a preferred structure of a synergistic processing element (SPE) 408 is illustrated. The SPE 408 architecture preferably fills a void between general-purpose processors (which are designed to achieve high average performance on a broad set of applications) and special-purpose processors (which are designed to achieve high performance on a single application). The SPE 408 is designed to achieve high performance on game applications, media applications, broadband systems, etc., and to provide a high degree of control to programmers of real-time applications. Some capabilities of the SPE 408 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The synergistic processing element 408 includes two basic functional units, namely a streaming processing unit (SPU) 410A and a memory flow controller (MFC) 410B. The SPU 410A performs program execution, data manipulation, etc., while the MFC 410B performs functions related to data transfers between the SPU 410A and the DRAM 414 of the system.

The SPU 410A includes a local memory 450, an instruction unit (IU) 452, registers 454, one ore more floating point execution stages 456 and one or more fixed point execution stages 458. The local memory 450 is preferably implemented using single-ported random access memory, such as an SRAM. Whereas most processors reduce latency to memory by employing caches, the SPU 410A implements the relatively small local memory 450 rather than a cache. Indeed, in order to provide consistent and predictable memory access latency for programmers of real-time applications (and other applications as mentioned herein) a cache memory architecture within the SPU 410A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 450 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the synergistic processing elements 408 references the associated local memory 450 using a local address. However, each location of the local memory 450 is also assigned a real address (RA) within the memory map of the overall system. This allows Privilege Software to map a local memory 450 into the Effective Address (EA) of a process to facilitate DMA transfers between one local memory 450 and another local memory 450. The PPE 404 can also directly access the local memory 450 using an effective address. In a preferred embodiment, the local memory 450 contains 556 kilobytes of storage, and the capacity of registers 452 is 128×128 bits.

The SPU 410A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 452 includes an instruction buffer, instruction decode circuitry, dependency check circuitry, and instruction issue circuitry.

The instruction buffer preferably includes a plurality of registers that are coupled to the local memory 450 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 450, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decode circuitry simultaneously.

The instruction issue circuitry is operable to issue the instructions to the floating point execution stages 456 and/or the fixed point execution stages 458.

The registers 454 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU 410A is of a superscalar architecture, such that more than one instruction is issued per clock cycle. The SPU 410A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 456 and fixed point execution stages 458 may be employed. In a preferred embodiment, the floating point execution stages 456 operate at a speed of 32 billion floating point operations per second (32 GFLOPS), and the fixed point execution stages 458 operate at a speed of 32 billion operations per second (32 GOPS).

The MFC 410B preferably includes a direct memory access controller (DMAC) 460, a memory management unit (MMU) 462, and a bus interface unit (BIU) 464. With the exception of the DMAC 460, the MFC 410B preferably runs at half frequency (half speed) as compared with the SPU 410A and the bus 412 to meet low power dissipation design objectives. The MFC 410B is operable to handle data and instructions coming into the SPE 408 from the bus 412, provides address translation for the DMAC, and snoop-operations for data coherency. The BIU 464 provides an interface between the bus 412 and the MMU 462 and DMAC 460. Thus, the SPE 408 (including the SPU 410A and the MFC 410B) and the DMAC 460 are connected physically and/or logically to the bus 412.

The MMU 462 is preferably operable to translate effective addresses (taken from DMA commands) into real addresses for memory access. For example, the MMU 462 may translate the higher order bits of the effective address into real address bits. The lower-order address bits, however, are preferably untranslatable and are considered both logical and physical for use to form the real address and request access to memory. In one or more embodiments, the MMU 462 may be implemented based on a 64-bit memory management model, and may provide 2⁶⁴ bytes of effective address space with 4K-, 64K-, 1M-, and 16M- byte page sizes and 256 MB segment sizes. Preferably, the MMU 462 is operable to support up to 265 bytes of virtual memory, and 2⁴² bytes (4 TeraBytes) of physical memory for DMA commands. The hardware of the MMU 462 may include an 8-entry, fully associative SLB, a 256-entry, 4 way set associative TLB, and a 4×4 Replacement Management Table (RMT) for the TLB—used for hardware TLB miss handling.

The DMAC 460 is preferably operable to manage DMA commands from the SPU 410A and one or more other devices such as the PPE 404 and/or the other SPUs. There may be three categories of DMA commands: Put commands, which operate to move data from the local memory 450 to the shared memory 414; Get commands, which operate to move data into the local memory 450 from the shared memory 414; and Storage Control commands, which include SLI commands and synchronization commands. The synchronization commands may include atomic commands, send signal commands, and dedicated barrier commands. In response to DMA commands, the MMU 462 translates the effective address into a real address and the real address is forwarded to the BIU 464.

The SPU 410A preferably uses a channel interface and data interface to communicate (send DMA commands, status, etc.) with an interface within the DMAC 460. The SPU 410A dispatches DMA commands through the channel interface to a DMA queue in the DMAC 460. Once a DMA command is in the DMA queue, it is handled by issue and completion logic within the DMAC 460. When all bus transactions for a DMA command are finished, a completion signal is sent back to the SPU 410A over the channel interface.

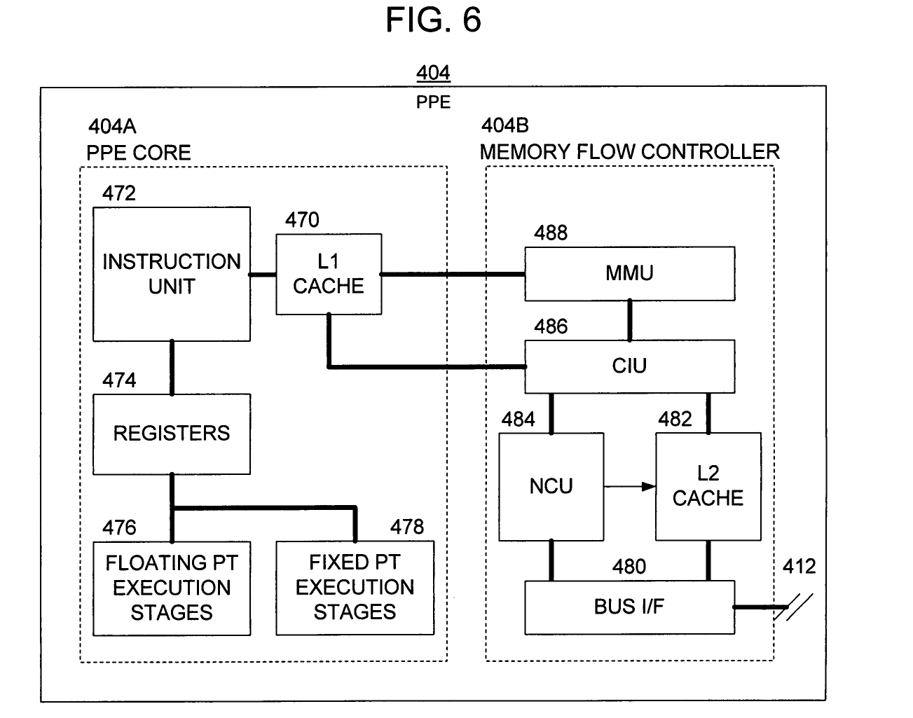

Referring to FIG. 6, a preferred structure of the PPE 404 is illustrated. The PPE 404 includes two basic functional units, the PPE core 404A and the memory flow controller (MFC) 404B. The PPE core 404A performs program execution, data manipulation, multi-processor management functions, etc., while the MFC 404B performs functions related to data transfers between the PPE core 404A and the memory space of the system 100.

The PPE core 404A may include an L1 cache 470, an instruction unit 472, registers 474, one or more floating point execution stages 476 and one or more fixed point execution stages 478. The L1 cache 470 provides data caching functionality for data received from the shared memory 414, the processors 408, or other portions of the memory space through the MFC 404B. As the PPE core 404A is preferably implemented as a superpipeline, the instruction unit 472 is preferably implemented as an instruction pipeline with many stages, including fetching, decoding, dependency checking, issuing, etc. The PPE core 404A is also preferably of a superscalar configuration, whereby more than one instruction is issued from the instruction unit 472 per clock cycle. To achieve a high processing power, the floating point execution stages 476 and the fixed point execution stages 478 include a plurality of stages in a pipeline configuration. Depending upon the required processing power, a greater or lesser number of floating point execution stages 476 and fixed point execution stages 478 may be employed.

The MFC 404B includes a bus interface unit (BIU) 480, an L2 cache memory 482, a non-cachable unit (NCU) 484, a core interface unit (CIU) 486, and a memory management unit (MMU) 488. Most of the MFC 404B runs at half frequency (half speed) as compared with the PPE core 404A and the bus 412 to meet low power dissipation design objectives.

The BIU 480 provides an interface between the bus 412 and the L2 cache 482 and NCU 484 logic blocks. To this end, the BIU 480 may act as a Master as well as a Slave device on the bus 412 in order to perform fully coherent memory operations. As a Master device it may source load/store requests to the bus 412 for service on behalf of the L2 cache 482 and the NCU 484. The BIU 480 may also implement a flow control mechanism for commands which limits the total number of commands that can be sent to the bus 412. The data operations on the bus 412 may be designed to take eight beats and, therefore, the BIU 480 is preferably designed around 128 byte cache-lines and the coherency and synchronization granularity is 128 KB.

The L2 cache memory 482 (with supporting hardware logic) is preferably designed to cache 512 KB of data. For example, the L2 cache 482 may handle cacheable loads/stores, data pre-fetches, instruction fetches, instruction pre-fetches, cache operations, and barrier operations. The L2 cache 482 is preferably an 8-way set associative system. The L2 cache 482 may include six reload queues matching six (6) castout queues (e.g., six RC machines), and eight (64-byte wide) store queues. The L2 cache 482 may operate to provide a backup copy of some or all of the data in the L1 cache 470. Advantageously, this is useful in restoring state(s) when processing nodes are hot-swapped. This configuration also permits the L1 cache 470 to operate more quickly with fewer ports, and permits faster cache-to-cache transfers (because the requests may stop at the L2 cache 482). This configuration also provides a mechanism for passing cache coherency management to the L2 cache memory 482.

The NCU 484 interfaces with the CIU 486, the L2 cache memory 482, and the BIU 480 and generally functions as a queuing/buffering circuit for non-cacheable operations between the PPE core 404A and the memory system. The NCU 484 preferably handles all communications with the PPE core 404A that are not handled by the L2 cache 482, such as cache-inhibited load/stores, barrier operations, and cache coherency operations. The NCU 484 is preferably run at half speed to meet the aforementioned power dissipation objectives.

The CIU 486 is disposed on the boundary of the MFC 404B and the PPE core 404A and acts as a routing, arbitration, and flow control point for requests coming from the execution stages 476, 478, the instruction unit 472, and the MMU unit 488 and going to the L2 cache 482 and the NCU 484. The PPE core 404A and the MMU 488 preferably run at full speed, while the L2 cache 482 and the NCU 484 are operable for a 2:1 speed ratio. Thus, a frequency boundary exists in the CIU 486 and one of its functions is to properly handle the frequency crossing as it forwards requests and reloads data between the two frequency domains.

The CIU 486 is comprised of three functional blocks: a load unit, a store unit, and reload unit. In addition, a data pre-fetch function is performed by the CIU 486 and is preferably a functional part of the load unit. The CIU 486 is preferably operable to: (i) accept load and store requests from the PPE core 404A and the MMU 488; (ii) convert the requests from full speed clock frequency to half speed (a 2:1 clock frequency conversion); (iii) route cachable requests to the L2 cache 482, and route non-cachable requests to the NCU 484; (iv) arbitrate fairly between the requests to the L2 cache 482 and the NCU 484; (v) provide flow control over the dispatch to the L2 cache 482 and the NCU 484 so that the requests are received in a target window and overflow is avoided; (vi) accept load return data and route it to the execution stages 476, 478, the instruction unit 472, or the MMU 488; (vii) pass snoop requests to the execution stages 476, 478, the instruction unit 472, or the MMU 488; and (viii) convert load return data and snoop traffic from half speed to full speed.

The MMU 488 preferably provides address translation for the PPE core 440A, such as by way of a second level address translation facility. A first level of translation is preferably provided in the PPE core 404A by separate instruction and data ERAT (effective to real address translation) arrays that may be much smaller and faster than the MMU 488.

In a preferred embodiment, the PPE 404 operates at 4-6 GHz, 10F04, with a 64-bit implementation. The registers are preferably 64 bits long (although one or more special purpose registers may be smaller) and effective addresses are 64 bits long. The instruction unit 472, registers 474 and execution stages 476 and 478 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

We claim:

1. A method of repairing a defect in a shared memory using a functional memory of an available circuit, the method comprising:
identifying the defect in the shared memory, the defect being located in a defective region having a defective region address; and,
assigning a repair region of the functional memory to function in place of the defective region, the repair region having a repair region address.

2. The method of claim 1, further comprising:
performing a memory check of the shared memory;
recording identification details about identifying the defect; and,
recording assignment details about assigning the repair region.

3. The method of claim 2, further comprising:
processing a memory access request sent to the defective region address;
cross-referencing the identification details and the assignment details; and
redirecting the memory access request to the repair region address.

4. The method of claim 3, further comprising:
adjusting a latency of the access request.

5. A method of managing a functional but available circuit, the method comprising:
identifying a need for a capability of the functional but available circuit elsewhere in an integrated circuit
utilizing the functional but available circuit to satisfy the need.

6. The method of claim 5, wherein:
the functional but available circuit is a memory circuit and the need arises due to a defect in a defective region of a shared memory in the integrated circuit; and
the utilizing includes redirecting to the memory circuit memory access requests addressed to the defective region.

7. The method of claim 5, wherein:
the functional but available circuit is an inactive processor circuit and the need arises due to a defect in an active processor circuit in the integrated circuit; and
the utilizing includes activating the inactive processor circuit and deactivating the active processor circuit.

8. The method of claim 5, further comprising:
tracking a functionality status of an available circuit for referencing after the need is identified; and
determining whether the functionality status of the available circuit indicates that the available circuit is able to satisfy the identified need.

9. A method of managing a plurality of circuits, the method comprising:
determining a functionality status of a circuit;
recording the functionality status of the circuit; and
deactivating a circuit determined to be available;
identifying a need for at least part of the available circuit;
reactivating the available circuit;
using the available circuit to satisfy the need; and
updating the functionality status of the available circuit.

10. A system comprising:
a plurality of circuits including a repair circuit and a repaired circuit;
the repair circuit having an available capability to perform a specific function, and
the repaired circuit having a defect preventing the repaired circuit from performing the specific function;
wherein the repair circuit is used to perform the specific function in place of the repaired circuit.

11. The system of claim 10, wherein:
the repair circuit includes an enabled functional memory including a repair region identified by a repair region address, and
the repaired circuit includes a repaired shared memory, having at least one defect in a defective region identified by a defective region address;
wherein the repair region functions in place of the defective region.

12. The system of claim 11, further comprising:
an address conversion table,
wherein the address conversion table maps the defective region address to the repair region address.

13. The system of claim 11, further comprising:
a redirection engine,
wherein the redirection engine redirects memory access requests from the defective region address to the repair region address.

14. The system of claim 13, wherein:
the redirection engine adjusts the latency of a memory access request redirected from the defective region address to the repair region address.
